(19) United States
(12) Patent Application Publication
(10) Pub. No.: US 2005/0138138 A1
(43) Pub. Date: Jun. 23, 2005

(54) Content provisioning for mobile devices using proximity awareness to a computer

(76) Inventors: Lenka M. Jelinek, Portland, OR (US); Muthu K. Kumar, Hillsboro, OR (US); Gunner D. Danneels, Bearverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/744,200

(22) Filed: Dec. 22, 2003

(51) Int. Cl. G06F 15/16

(52) U.S. Cl. 709/217

(57) ABSTRACT

In some embodiments, content is cached on behalf of a mobile device. The cached content is downloaded to the mobile device. Other embodiments are described and claimed.

### TECHNICAL FIELD

The inventions generally relate to content provisioning for mobile devices using proximity awareness to a computer.

### BACKGROUND

Today's computing enterprise infrastructure is increasingly influenced and controlled by the Information Technology (IT) department. Managing computers within a corporation has become more and more challenging. Keeping these computing corporate assets “up to date” with the latest security patches, improvements and OS (operating system) updates is no longer a trivial task. Corporate Information Technology (IT) departments typically push update content to corporate computers connected to the corporate network for maintenance purposes of the corporate computers (for example, a corporate automated patch).

Unlike most desktop computers and many laptop computers, handheld mobile devices are not generally tethered to other computers, servers or the corporate network. Handheld mobile devices such as cell phones tend to come and go in and out of the network range (including wireless networks in a home of the user or a corporation where the user is an employee). Since they are highly portable, handheld mobile devices may not have access to a high-bandwidth data pipe very often or at extended intervals. This is particularly true in cases, for example, of a cell phone of an employee being connected to a corporate network, where that employee is not in the corporate offices very often (for example, a sales person that is on the road most of the time).

Cell phone providers have previously pushed update information to cell phones via the GSM/GPRS cellular network. However, that data pipe is small, which limits downloads to being very small in size. Additionally, the download content is typically limited to what the network operator (or maybe the device operator) wants to update. Further, it does not send down content to the cell phone that is relevant to a particular corporation (for example, it does not send a corporate network patch to a cell phone whose user is an employee of the corporation sending the corporate network patch).

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 is a block diagram representation illustrating a system according to some embodiments of the inventions.

### DETAILED DESCRIPTION

Some embodiments of the inventions relate to content provisioning for mobile devices using proximity awareness to a computer.

In some embodiments, content is cached on behalf of a mobile device, and the cached content is downloaded to the mobile device. In some embodiments, the caching and the downloading are performed by a computer. In some embodiments the caching and the downloaded are performed by software. In some embodiments the caching and the downloaded are performed by hardware.

In some embodiments an apparatus includes a caching unit to cache content on behalf of a mobile device, and a downloading unit to download the cached content to the mobile device.

In some embodiments, a system includes a network, a mobile device, and a computer coupled to the network. The computer includes a caching unit to cache content received from the network on behalf of the mobile device, and a downloading unit to download the cached content to the mobile device.

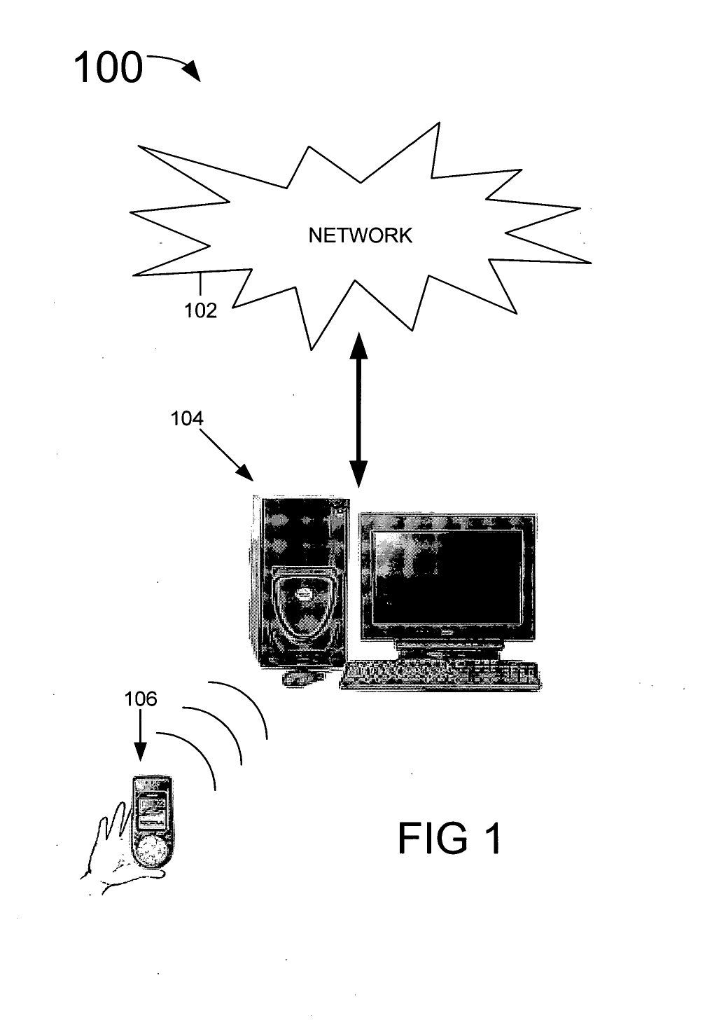

FIG. 1 illustrates a system 100 according to some embodiments. System 100 includes a network 102, a computer 104 and a mobile handheld device 106. In some embodiments network 102 is an Information Technology (IT) network (for example, a corporate IT department network). In some embodiments network 102 is a personal network (for example, in a home of a user of the computer 104 and/or the mobile handheld device 106). In some embodiments network 102 is a public network (for example, a WiFi network provided in a public space, either for a fee or for no fee). In some embodiments computer 104 is a server, a personal computer (PC), a desktop computer and/or a laptop computer (either in a corporate network environment, a personal network environment such as a home and/or some other environment). In some embodiments mobile handheld device 106 is a cellular phone, a PDA, an MP3 player, a small form factor device, a form factor laptop, a micro-PC, smart communicator device (voice and data), mini data storage device (for example USB keys with some processing abilities), portable electronic device, portable media player and/or portable video player (for example, portable DVD player, portable hard drive player, etc.), portable gaming device, and/or some other type of mobile handheld device.

Computer 104 determines and/or knows the characteristics of the user's mobile device 106. This may be accomplished in one or more of many different ways. For example, the computer 104 can sense the type of mobile device 106 (for example, “Nokia 3650 cell phone”) and determine various characteristics of that phone by receiving them from over the network 102, from the internet and/or consulting a file within the computer for the information. In some embodiments a user can input characteristics of the mobile device 106. In some embodiments a user can input the type of the mobile device 106 (for example, “Nokia cell phone 3650”), and the computer can determine characteristics of that device in response to the type of device entered by the user.

Characteristics of mobile device 106 determined by and/or stored by computer 104 according to some embodiments could be, for example:
Nokia 3650:
IT patch #23 installed? YES
Network profile enabled: YES
User pwd expires in: 28 days

The computer 104 can cache data on behalf of the mobile device 106. According to some embodiments computer 104 can cache patches such as security patches, upgrades such as software upgrades, updates such as operating system (OS) updates and/or any other relevant content for the user's mobile device 106. For example, computer 104 can cache software patches intended for mobile device 106 that are provided by an IT department over the network 102. Then, when the mobile device 106 is within the proximity of the computer 104 (for example, in wireless communication with the computer) the computer 104 detects the presence of the mobile device and starts downloading necessary content to the mobile device using convenient communication transports (for example, Bluetooth, an IEEE 802.11 connection such as adhoc 802.11 connection, etc.). In some embodiments the computer may be in any proximity with the mobile device such that the communication transport is able to communicate (for example, in some embodiments in the same building as each other). In some embodiments any currently known or future communications transports may be implemented. In accordance with some embodiments any of the following may be used as communication transports between the computer and the mobile device: Bluetooth, an IEEE 802.11 connection such as adhoc 802.11 connection, Aura, Zigbee (IEEE 802.15.4), UWB (IEEE 802.15.3) and/or others.

Using the computer 104 provision content for the mobile device 106 is advantageous, for example, because a computer typically has more storage space than a mobile device and likely much more frequent access to a high bandwidth connection than a mobile device. Therefore, the computer 104 can manage a user's handheld devices (for example, on behalf of the IT department). There are several additional reasons why providing content over a computer (or other caching device) according to some embodiments is better than providing content directly to a mobile device. For example, a connection between a computer (or other caching device) and the mobile device is faster, cheaper, more secure, consumes less power and/or is more convenient than getting content directly from a provider to a mobile device.

In some embodiments computer 104 preemptively caches all patches, upgrades, OS updates and any other relevant content for the mobile device 106. When the mobile device 106 (for example, a cellular phone) is in a proximity of the computer 104, the computer 104 detects the presence of the mobile device 106 and starts downloading necessary content to the mobile device 106 over convenient transports. Although content has been described as transferring from the computer 104 to the mobile device 106 data and/or content can also travel back from the mobile device 106 to the computer 104 according to some embodiments. Additionally, although some embodiments have been described above in reference to the computer 104 detecting the presence of the mobile device 106, in some embodiments the mobile device 106 detects the presence of the computer 104.

Although embodiments have been described above as occurring in the corporate world, other embodiments are not limited to the corporate world or corporate world IT department use. For example, system 100 could be implemented in a personal environment of a user. A user could use the interaction between computer 104 and mobile device 106 in their personal (for example, home) environment (for example, using a home computer as computer 104) instead of or in addition to a corporate network environment. In environments according to some embodiments such as corporate, public, and personal environments the proximity between the computer and the mobile device provides an additional level of trust for the content provisioning.

Although some embodiments herein have described computer 104 as a desktop computer such as a desktop PC, a laptop can be used according to some embodiments. For example, according to some embodiments a laptop computer 104 caches content for the mobile device 106 and pushes it to the mobile device 106 when the user is traveling. In some embodiments computer 104 is a server that caches content for the mobile device 106. In some embodiments computer 104 is any entity that has the capacity to cache content on behalf of the mobile device.

Although some embodiments have been described in reference to particular implementations such as provisioning of content from an Information Technology (IT) department of a corporation, other implementations are possible according to some embodiments. For example, implementations described herein may be used, for example, to provide content caching and content provisioning within a personal network environment of a user (such as a home network of a user of a handheld mobile device) according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1. A method comprising:
caching content on behalf of a mobile device; and
downloading the cached content to the mobile device.

2. The method according to claim 1, wherein the caching preemptively caches the content on behalf of the mobile device.

3. The method according to claim 1, wherein the content includes at least one of an improvement, a patch, a security patch, an upgrade, a software upgrade, an update and an operating system update.

4. The method according to claim 1, further comprising a detecting of a proximity of the mobile device, wherein the downloading is in response to the detecting.

5. The method according to claim 1, wherein the mobile device is a cell phone.

6. An article comprising:
a computer readable medium having instructions thereon which when executed cause a computer to:
cache content on behalf of a mobile device; and
download the cached content to the mobile device.

7. The article according to claim 6, wherein the caching preemptively caches the content on behalf of the mobile device.

8. The article according to claim 6, wherein the content includes at least one of an improvement, a patch, a security patch, an upgrade, a software upgrade, an update and an operating system update.

9. The article according to claim 6, the computer readable medium further having instructions thereon which when executed cause a computer to detect a proximity of the mobile device, and to download the cached content to the mobile device in response to the detected proximity.

10. An apparatus comprising:
a caching unit to cache content on behalf of a mobile device; and
a downloading unit to download the cached content to the mobile device.

11. The apparatus according to claim 10, the caching unit to preemptively cache the content on behalf of the mobile device.

12. The apparatus according to claim 10, wherein the content includes at least one of an improvement, a patch, a security patch, an upgrade, a software upgrade, an update and an operating system update.

13. The apparatus according to claim 10, further comprising a detecting unit to detect a proximity of the mobile device, wherein the downloading unit is to download the cached content in response to the detecting unit.

14. The apparatus according to claim 10, wherein the mobile device is a cell phone.

15. The apparatus according to claim 10, wherein the apparatus is included in a computer.

16. The apparatus according to claim 10, wherein the apparatus receives the content over a network.

17. The apparatus according to claim 10, wherein the apparatus receives the content over a high bandwidth connection.

18. A system comprising:
a network;
a mobile device;
a computer coupled to the network, the computer including:
a caching unit to cache content received from the network on behalf of the mobile device; and
a downloading unit to download the cached content to the mobile device.

19. The system according to claim 18, the caching unit to preemptively cache the content on behalf of the mobile device.

20. The system according to claim 18, wherein the content includes at least one of an improvement, a patch, a security patch, an upgrade, a software upgrade, an update and an operating system update.

21. The system according to claim 18, the computer further including a detecting unit to detect a proximity of the mobile device, wherein the downloading unit is to download the cached content in response to the detecting unit.

22. The system according to claim 18, wherein the mobile device is a cell phone.

23. The system according to claim 18, wherein the apparatus is included in a computer.

24. The system according to claim 18, wherein the network is a corporate network.

25. The system according to claim 18, wherein the content is Information Technology content.

26. The system according to claim 18, wherein the network is a personal environment network.
